(19) United States
(12) Patent Application Publication
(10) Pub. No.: US 2025/0235808 A1
(43) Pub. Date: Jul. 24, 2025

(54) Air Filter Device

(71) Applicant: Cleveland Pulliam, Arlington, TN (US)

(72) Inventor: Cleveland Pulliam, Arlington, TN (US)

(21) Appl. No.: 18/415,855

(22) Filed: Jan. 18, 2024

(51) Int. Cl. B01D 46/42; B01D 46/00

(52) U.S. Cl. CPC B01D 46/4227; B01D 46/0002

(57) ABSTRACT

A air filter device for facilitating insertion and removal of the air filter from an air conditioning unit includes a filter element that is positionable within an air conditioning unit. A frame is coupled to and extends around the filter element. A handle is coupled to the frame facilitate a user in removing the frame and the filter element from the air conditioning unit. The handle is movably coupled to the frame wherein the handle is extendable and retractable relative to the frame. A cutout extends into the frame and is aligned with the handle. The handle is positionable within the cutout. The handle retracts into the cutout and extends outwardly from the cutout when the handle is extended and retracted. An outer surface of the handle is flush with an exterior side of the frame when the handle is fully retracted relative to frame.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to air filters and more particularly pertains to a new air filter for facilitating insertion and removal of the air filter from an air conditioning unit.

### (2) Description of Related Art Including Information Disclosed Under 37 CFR 1.97 and 1.98

The prior art relates to air filters. More particularly, the prior art relates to air filters that are positionable within air conditioning units to filter the air within a dwelling or building. The air conditioning units typically have a narrow slot for receiving the air filters. The air filter can be difficult to grip or grasp when the air filter is inserted into the slot. The narrow slot may also have sharp edges, posing a danger to a user who is trying to replace the air filter without using protective hand coverings. Some people use knives or screwdrivers to pry the used air filters out of the air conditioning unit, which can also be dangerous and risk injury. Thus, there is a need for an air filter device that includes handles to facilitate the user in removing the air filter from the air conditioning unit. Ideally, the handles would extend and retract from the edges of the air filter so that the air filter retains its size and compatibility with existing air conditioning units.

### BRIEF SUMMARY OF THE INVENTION

An embodiment of the disclosure meets the needs presented above by generally comprising a filter element that is configured to be positioned within an air conditioning unit. A frame is coupled to and extends around the filter element. A handle is coupled to the frame wherein the handle is configured to facilitate a user in removing the frame and the filter element from the air conditioning unit. The handle is movably coupled to the frame wherein the handle is extendable and retractable relative to the frame. A cutout extends into the frame. The cutout is aligned with the handle. The cutout has a shape that is complementary to a shape of the handle wherein the handle is positionable within the cutout when the handle is retracted relative to the frame and wherein the handle is extendable outwardly from the cutout when the handle is extended relative to the frame. An outer surface of the handle is flush with an exterior side of the frame when the handle is fully retracted relative to frame.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of an air filter device according to an embodiment of the disclosure.

FIG. 2 is an isometric view of an embodiment of the disclosure.

FIG. 3 is a rear view of an embodiment of the disclosure.

FIG. 4 is a side view of an embodiment of the disclosure.

FIG. 5 is a cross-sectional view of an embodiment of the disclosure.

FIG. 6 is a cross-sectional view of an embodiment of the disclosure.

FIG. 7 is an in-use view of an embodiment of the disclosure.

FIG. 8 is an in-use view of an embodiment of the disclosure.

FIG. 9 is a detail view of an embodiment of the disclosure.

### DETAILED DESCRIPTION OF THE INVENTION

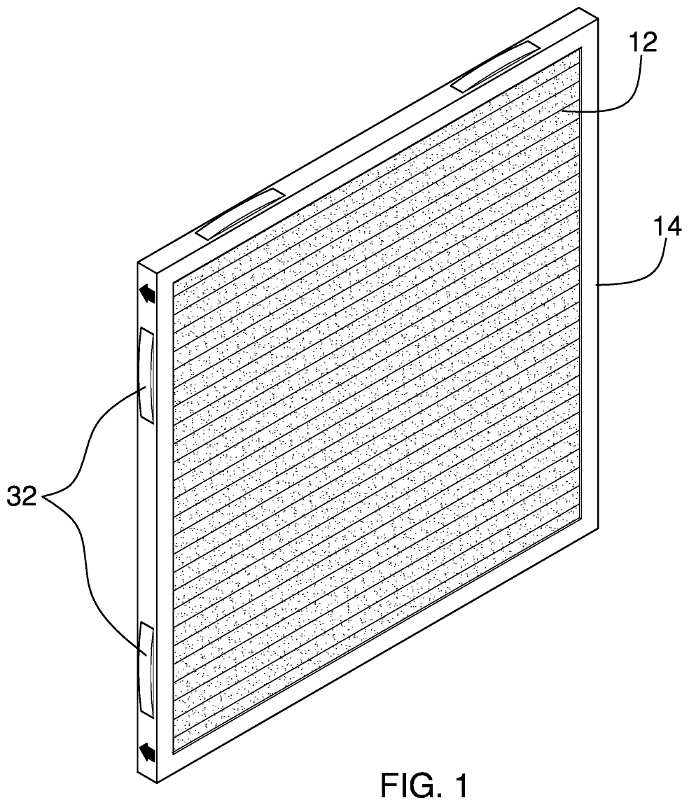

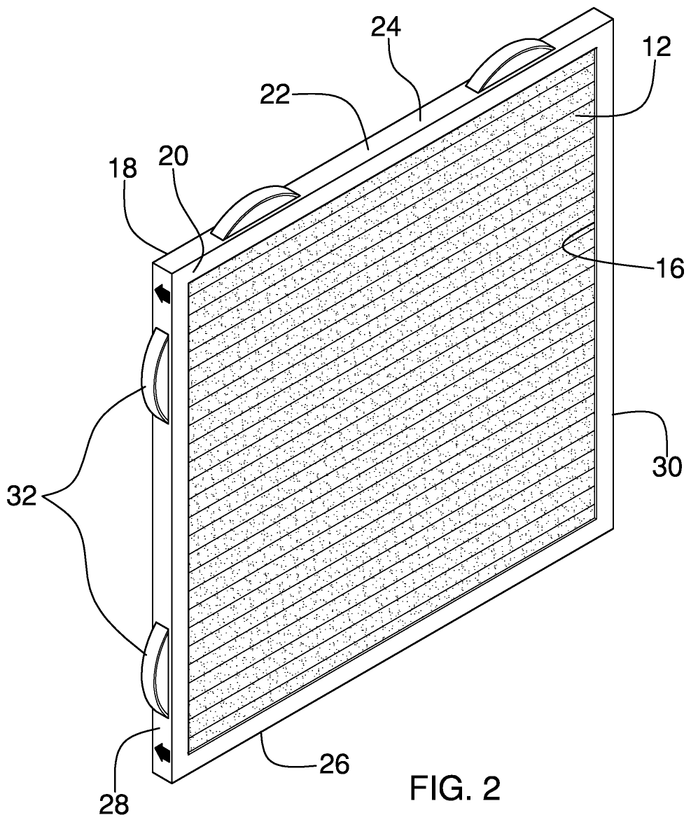

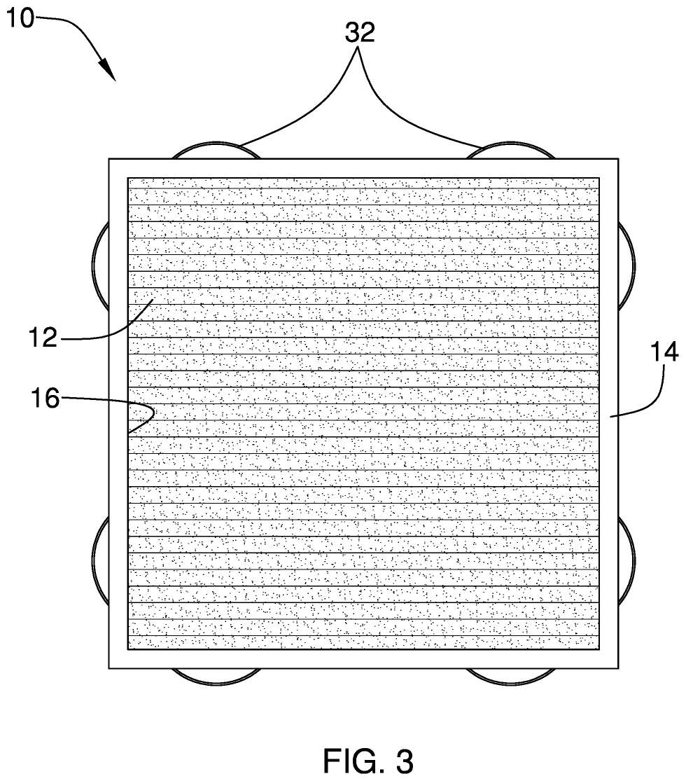

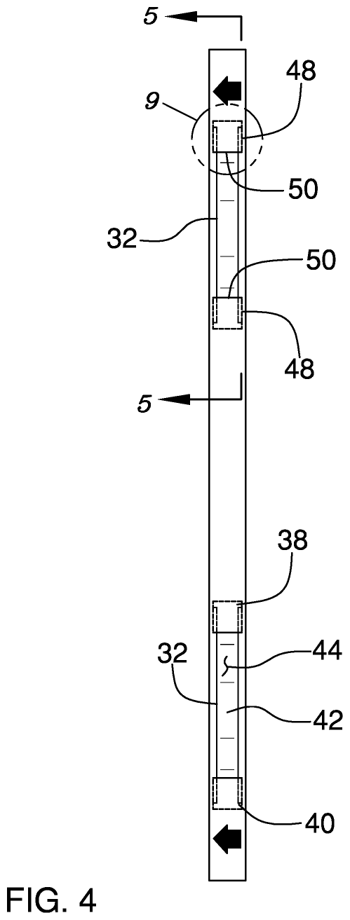

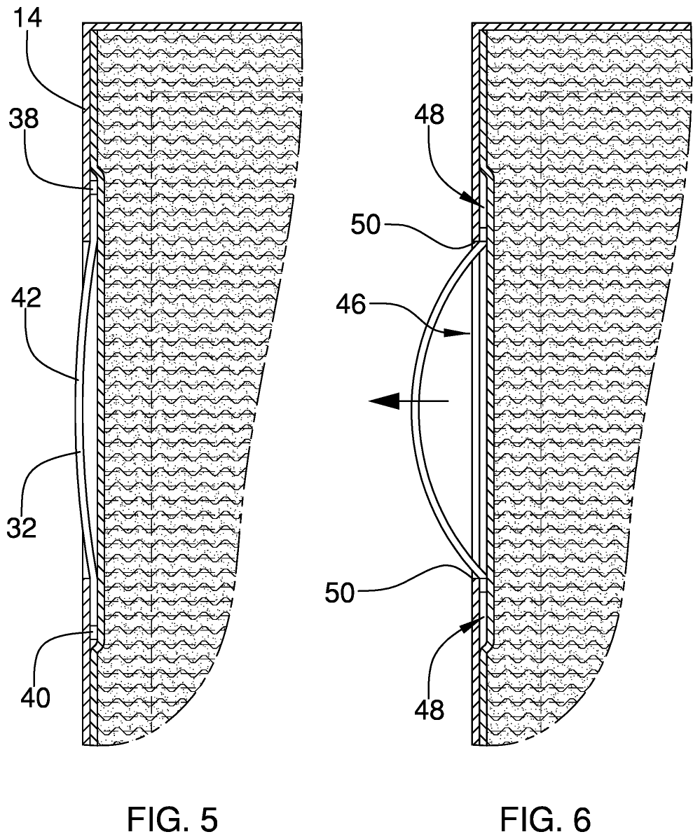

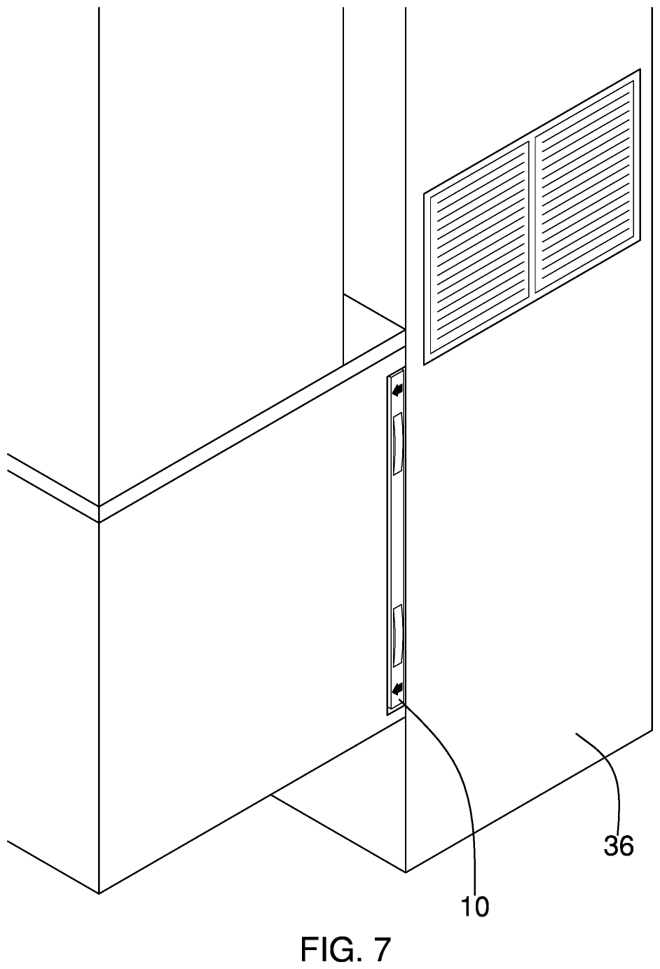

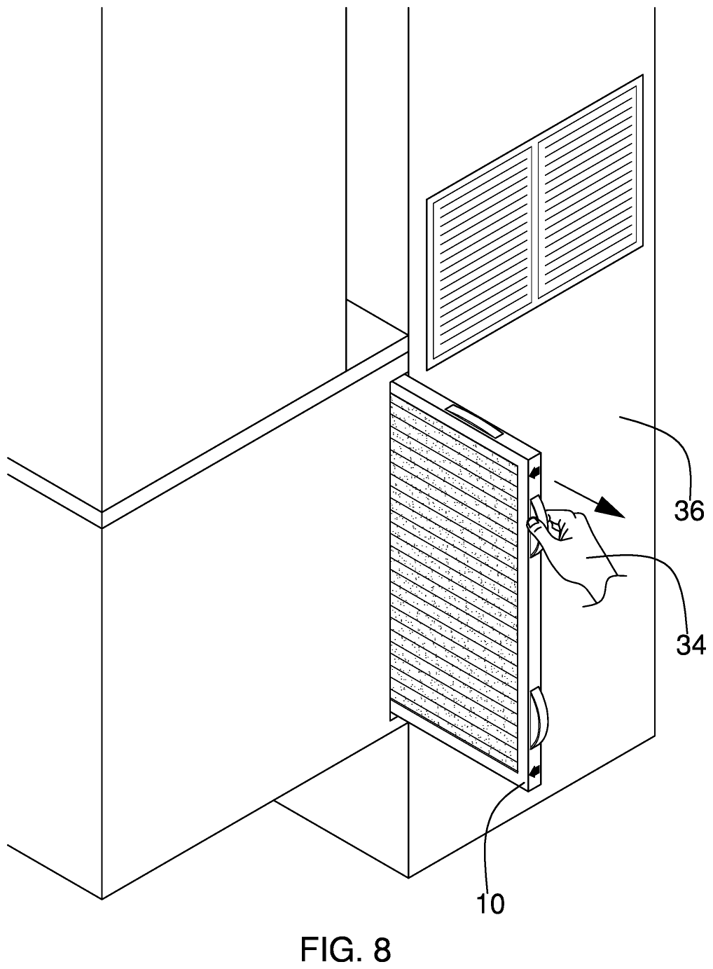

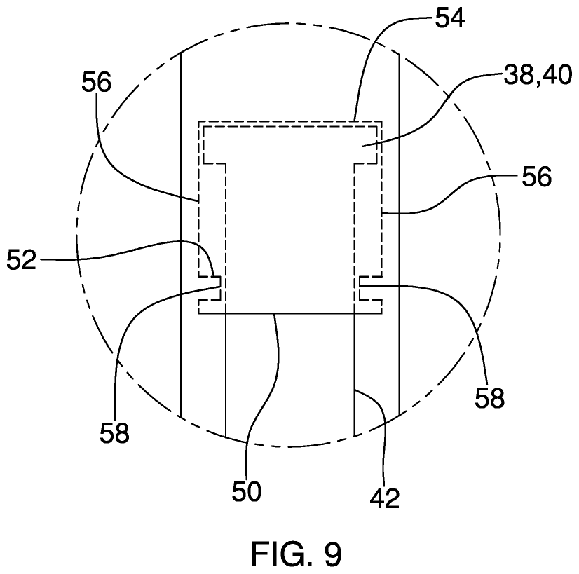

With reference now to the drawings, and in particular to FIGS. 1 through 9 thereof, a new air filter embodying the principles and concepts of an embodiment of the disclosure and generally designated by the reference numeral 10 will be described.

As best illustrated in FIGS. 1 through 9, the air filter device 10 generally comprises a filter element 12 that is configured to be removably positionable within an air conditioning unit 36 for filtering debris from air traveling through the air conditioning unit 36. A frame 14 is coupled to the filter element 12. The frame 14 may extend around a perimeter 16 of the filter element 12. For example, the frame 14 may extend completely around all of the perimeter 16 of the filter element 12, or may extend partially around some of the perimeter 16 of the filter element 12.

The frame 14 may further comprise a front wall 18, back wall 20, and a peripheral wall 22 that is coupled to and extends between the front wall 18 and the back wall 20. The peripheral wall 22 may have a top side 24, a bottom side 26, a first lateral side 28, and a second lateral side 30.

A plurality of handles 32 may be coupled to the frame 14 wherein the plurality of handles 20 is configured to facilitate a user 34 in removing the frame 14 and the filter element 12 from the air conditioning unit 36. The plurality of handles 32 may be positioned on one or more of the top side 24, the bottom side 26, the first lateral side 28, and the second lateral side 30 of the peripheral wall 22 of the frame 12. Each of the plurality of handles 32 is movably coupled to the frame 14 wherein the plurality of handles 32 is outwardly extendable and inwardly retractable relative to the frame 14.

Each handle of the plurality of handles 32 may further comprise a primary end 38 and a secondary end 40. The secondary end 40 is generally distal to the primary end 38. An elongated body 42 is coupled to and extends between the primary end 38 and the secondary end 40. The elongated body 42 has an outer surface 44 that may be flush with the peripheral wall 22 when the respective handle 32 is fully retracted into the frame 14. The outer surface 44 may be spaced from the peripheral wall 22 when the respective handle 32 is fully extended from the frame 14.

A plurality of cutouts 46 may extend into the frame 14. The plurality of cutouts 46 is aligned with the plurality of handles 32. The plurality of cutouts have a shape that is complementary to the plurality of handles 32 wherein the respective handle 32 is positionable within a respective cutout of the plurality of cutouts 46 when the respective handle 32 is retracted relative to the frame 14 and wherein the respective handle 32 is extendable outwardly from the respective cutout 46 when the respective handle 32 is extended relative to the frame 14.

Each of the primary end 38 and the secondary end 40 of the respective handle 32 may have a width exceeding a width of the elongated body 42 of the respective handle 32.

A pair of end pockets 48 may extend into the frame 14. Each end pocket of the pair of end pockets 48 is aligned with a lateral edge of a pair of opposing lateral edges 50 of the respective cutout 46 to receive one of the primary end 38 and the secondary end 40 of the respective handle 32. Each of the primary end 38 and the secondary end 40 of the respective handle 32 may be slidably engaged with one of the pair of end pockets 48 to facilitate extension and retraction of the respective handle 32.

Each end pocket of the pair of end pockets 48 may further comprise an open end 52. The open end 52 may be positioned adjacent to the lateral edge of the pair of opposing lateral edges 50 of the respective cutout 46. A closed end 54 may be spaced from the open end 52. A pair of sides 56 may extend between the open end 52 and the closed end 54. A width between the pair of sides 56 may be greater than a width of the one of the primary end 38 and the secondary end 40 of the respective handle 32.

The respective handle 32 may slide toward the open end 52 when the respective handle 32 is extended. The respective handle 32 may slide toward the closed end 54 when the respective handle 32 is retraced.

A catch 58 may into each of the pair of end pockets 48. The catch 58 may be positioned between the open end 52 of each of the pair of end pockets 48 and the lateral edge of the pair of opposing lateral edges 50 of the respective cutout 46. The catch 58 may have a width that is smaller than the width of the one of the primary end 38 and the secondary end 40 of the respective handle 32. The catch 58 retains the one of the primary end 38 and the secondary end 40 of the respective handle 32 within the one of the pair of end pockets 48. The catch 58 may have a width exceeding a width of the elongated body 42 of the respective handle 32 wherein the elongated body 42 of the respective handle 32 is movable through the catch 58.

In use, the user 34 can position the air filter device 10 within the air conditioning unit 12 as usual. Because the plurality of handles 32 are flush with the frame 14 when fully retracted, the air filter device 10 is compatible with existing air conditioning units and other heating, ventilation, and air conditioning systems. The air filter device 10 can be manufactured to the same dimensions as existing air filters. However, inserting and removing the air filter device 10 is facilitated by the plurality of handles 32, which can extend outwardly from the frame 14 to facilitate the user 34 in gripping air filter device 10.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An air filter assembly comprising:
a filter element being configured to be positioned within an air conditioning unit;
a frame being coupled to the filter element;
a handle being coupled to the frame wherein the handle is configured to facilitate a user in removing the frame and the filter element from the air conditioning unit, the handle being movably coupled to the frame wherein the handle is extendable and retractable relative to the frame;
a cutout extending into the frame, the cutout being aligned with the handle, the cutout having a shape being complementary to a shape of the handle wherein the handle is positionable within the cutout when the handle is retracted relative to the frame and wherein the handle is extendable outwardly from the cutout when the handle is extended relative to the frame;
wherein an outer surface of the handle is flush with an exterior side of the frame when the handle is fully retracted relative to frame.

2. The air filter assembly of claim 1, wherein the frame extends completely around a perimeter of the filter element.

3. The air filter assembly of claim 1, the handle further comprising:
a primary end;
a secondary end being distal to the primary end; and
an elongated body being coupled to and extending between the primary end and the secondary end.

4. The air filter assembly of claim 3, wherein each of the primary end and the secondary end of the handle has a width exceeding a width of the elongated body of the handle.

5. The air filter assembly of claim 3, further comprising a pair of end pockets extending into the frame, each end pocket of the pair of end pockets being aligned with a lateral edge of the cutout to receive one of the primary end and the secondary end of the handle, each of the primary end and the secondary end of the handle being slidably engaged with one of the pair of end pockets to facilitate extension and retraction of the handle.

6. The air filter assembly of claim 5, each end pocket of the pair of end pockets further comprising:
an open end;
a closed end being spaced from the open end; and
a pair of sides extending between the open end and the closed end.

7. The air filter assembly of claim 6, wherein a width between the pair of sides is greater than a width of the one of the primary end and the secondary end of the handle.

8. The air filter assembly of claim 6, wherein the handle slides toward the open end when the handle is extended.

9. The air filter assembly of claim 6, wherein the respective handle slides toward the closed end when the respective handle is retraced.

10. The air filter assembly of claim 5, further comprising a catch extending into each of the pair of end pockets, the catch having a width being smaller than a width of the one of the primary end and the secondary end of the handle wherein the catch retains the one of the primary end and the secondary end of the handle within the one of the pair of end pockets.

11. The air filter assembly of claim 10, wherein the catch has a width exceeding a width of the elongated body of the handle and wherein the elongated body of the handle is movable through the catch.

12. The air filter assembly of claim 10, wherein the catch is positioned between the open end of each of the pair of end pockets and the lateral edge of the pair of opposing lateral edges of the cutout.

13. An air filter assembly comprising:
a filter element being configured to be removably positionable within an air conditioning unit for filtering debris from air traveling through the air conditioning unit;
a frame being coupled to and extending around a perimeter of the filter element, the frame further comprising:
a front wall;
a back wall;
a peripheral wall being coupled to and extending between the front wall and the back wall, the peripheral wall having a top side, a bottom side, a first lateral side, and a second lateral side;
a plurality of handles being coupled to the frame wherein the plurality of handles is configured to facilitate a user in removing the frame and the filter element from the air conditioning unit, the plurality of handles being positioned on one or more of the top side, the bottom side, the first lateral side, and the second lateral side of the peripheral wall of the frame, the plurality of handles being movably coupled to the frame wherein the plurality of handles is outwardly extendable and inwardly retractable relative to the frame, each handle of the plurality of handles further comprising:
a primary end;
a secondary end being distal to the primary end;
an elongated body being coupled to and extending between the primary end and the secondary end, the elongated body having an outer surface being flush with the peripheral wall when the respective handle is fully retracted into the frame, the outer surface being spaced from the peripheral wall when the respective handle is fully extended from the frame;
a plurality of cutouts extending into the frame, the plurality of cutouts being aligned with the plurality of handles, the plurality of cutouts having a shape being complementary to the plurality of handles wherein the respective handle is positionable within a respective cutout of the plurality of cutouts when the respective handle is retracted relative to the frame and wherein the respective handle is extendable outwardly from the respective cutout when the respective handle is extended relative to the frame;
wherein each of the primary end and the secondary end of the respective handle has a width exceeding a width of the elongated body of the respective handle;
a pair of end pockets extending into the frame, each end pocket of the pair of end pockets being aligned with a lateral edge of a pair of opposing lateral edges of the respective cutout to receive one of the primary end and the secondary end of the respective handle, each of the primary end and the secondary end of the respective handle being slidably engaged with one of the pair of end pockets to facilitate extension and retraction of the respective handle, each end pocket of the pair of end pockets further comprising:
an open end being positioned adjacent to the lateral edge of the pair of opposing lateral edges of the respective cutout;
a closed end being spaced from the open end;
a pair of sides extending between the open end and the closed end, wherein a width between the pair of sides is greater than a width of the one of the primary end and the secondary end of the respective handle;
wherein the respective handle slides toward the open end when the respective handle is extended and wherein the respective handle slides toward the closed end when the respective handle is retraced; and
a catch extending into each of the pair of end pockets, the catch being positioned between the open end of each of the pair of end pockets and the lateral edge of the pair of opposing lateral edges of the respective cutout, the catch having a width being smaller than the width of the one of the primary end and the secondary end of the respective handle wherein the catch retains the primary end and the secondary end of the handle within the pair of end pockets, wherein the catch has a width exceeding a width of the elongated body of the respective handle wherein the elongated body of the respective handle is movable through the catch.
